(19) United States
(12) Patent Application Publication
(10) Pub. No.: US 2021/0027142 A1
(43) Pub. Date: Jan. 28, 2021

(54) NEURAL NETWORK SYSTEM AND OPERATING METHOD OF THE SAME

(71) Applicant: Postech Research and Business Development Foundation, Pohang-si (KR)

(72) Inventors: Hyungjun KIM, Pohang-si (KR); Yulhwa KIM, Daegu (KR); Sungju RYU, Busan (KR); Jae-Joon KIM, Pohang-si (KR)

(21) Appl. No.: 16/933,889

(22) Filed: Jul. 20, 2020

(30) Foreign Application Priority Data
Jul. 23, 2019 (KR) 10-2019-0088879

(51) Int. Cl. G06N 3/04; G06N 3/08; G06T 1/20

(52) U.S. Cl. CPC G06N 3/0454; G06T 1/20; G06N 3/082

(57) ABSTRACT

Disclosed is a method of operating a neural network system. The method includes splitting input feature data into first splitting data corresponding to a first digit bit and second splitting data corresponding to a second digit bit different from the first digit bit, propagating the first splitting data through a first binary neural network, propagating the second splitting data through a second binary neural network, and merging first result data by propagation of the first splitting data and second result data by propagating the second splitting data to generate output feature data.

### CROSS-REFERENCE TO RELATED APPLICATIONS

This application claims priority under 35 U.S.C. § 119 to Korean Patent Application No. 10-2019-0088879 filed on Jul. 23, 2019, in the Korean Intellectual Property Office, the disclosures of which are incorporated by reference herein in their entireties.

### BACKGROUND

Embodiments of the inventive concept described herein relate to data analysis, and more particularly, relate to a neural network system and operating method of the same.

Neural network system is hardware that analyzes and processes data by imitating the human brain. The neural network system may analyze and process data, based on various neural network algorithms. To reduce a memory usage and a computational amount for data analysis, a method of reducing a precision of data used in a neural network is required.

A binary neural network (BNN) is a network that represents weights and activation values of a network in 1 bit. Since the binary neural network requires a small amount of computation and less memory usage, the binary neural network may be suitable for use in an environment such as a mobile system. However, the binary neural network may have a disadvantage in that system performance decreases as precision decreases to 1 bit. Therefore, while securing an effect of reducing a computation amount and reducing a memory usage, there is a need for a neural network system capable of increasing a performance of a system and a method of operating the same.

### SUMMARY

Embodiments of the inventive concept provide a neural network system and a method of operating the same, which improves data analysis performance using multiple bits and reduces a computational amount and a memory usage for data analysis.

According to an exemplary embodiment of the inventive concept, a method of operating a neural network system includes splitting input feature data into first splitting data corresponding to a first digit bit and second splitting data corresponding to a second digit bit different from the first digit bit, propagating the first splitting data through a first binary neural network, propagating the second splitting data through a second binary neural network, and merging first result data by propagation of the first splitting data and second result data by propagating the second splitting data to generate output feature data.

According to an exemplary embodiment, the splitting of the input feature data into the first splitting data and the second splitting data may include generating the first splitting data, based on a first activation function that converts the input feature data in a first reference range to a first value, and generating the second splitting data, based on a second activation function that converts the input feature data in a second reference range to a second value.

According to an exemplary embodiment, the first reference range may include a range between a half value of a valid range of the input feature data and a maximum value of the valid range, and the second reference range may include a first sub-range including at least a portion between a minimum value of the valid range and the half value and a second sub range including at least a portion between the half value and the maximum value. The first value may be greater than the second value.

According to an exemplary embodiment, the first activation function may convert the input feature data having a value less than ½ to 0, and may convert the input feature data having a value of ½ or more to ⅔, and the second activation function may convert the input feature data having a value less than ⅙ or a value from ½ to ⅚ to 0, and may convert the input feature data having a value from ⅙ to ½ or a value of ⅚ or more to ⅓.

According to an exemplary embodiment, the first digit bit may be a most significant bit, and the second digit bit may be a least significant bit.

According to an exemplary embodiment, the propagating of the first splitting data may include generating the first result data, based on an operation of a weight parameter group and the first splitting data, and the propagating of the second splitting data may include generating the second result data, based on an operation of the weight parameter group and the second splitting data. The weight parameter group includes weights of 1 bit.

According to an exemplary embodiment of the inventive concept, a neural network system includes a processor that converts input feature data into output feature data, based on a weight group parameter, and a memory that stores the weight group parameter. The processor may be configured to split the input feature data into first splitting data corresponding to a first digit bit and second splitting data corresponding to a second digit bit different from the first digit bit, to convert the first splitting data into first result data, based on a first binary neural network and the weight group parameter, to convert the second splitting data into second result data, based on a second binary neural network and the weight group parameter, and to merge the first result data and the second result data to generate the output feature data.

According to an exemplary embodiment, the first splitting data may be propagated through the first binary neural network, and the second splitting data may be propagated through the second binary neural network independently of the first splitting data.

According to an exemplary embodiment, the processor may generate the first splitting data, based on a first activation function that converts the input feature data in a first reference range to a first value, and may generate the second splitting data, based on a second activation function that converts the input feature data in a second reference range to a second value. The first reference range may include a range between a half value of a valid range of the input feature data and a maximum value of the valid range, and the second reference range may include a first sub-range including at least a portion between a minimum value of the valid range and the half value and a second sub range including at least a portion between the half value and the maximum value. The first value may be greater than the second value.

According to an exemplary embodiment, the first digit bit may be a most significant bit, and the second digit bit may be a least significant bit. According to an exemplary embodiment, a weight provided to the first binary neural network and a weight provided to the second binary neural network may be the same as the weight parameter group. The weight parameter group may include weights of 1 bit.

According to an exemplary embodiment, the processor may include a graphics processing unit.

### BRIEF DESCRIPTION OF THE FIGURES

The above and other objects and features of the inventive concept will become apparent by describing in detail exemplary embodiments thereof with reference to the accompanying drawings.

FIG. 1 is a block diagram of a neural network system according to an embodiment of the inventive concept.

FIG. 2 is an exemplary flowchart describing an operating method of a neural network system of FIG. 1.

FIG. 3 is a diagram exemplarily illustrating a neural network described in FIGS. 1 and 2.

FIG. 4 is an exemplary graph of an activation function used in operation S110 of FIGS. 2 and 3.

FIG. 5 is a diagram illustrating an algorithm for performing a splitting operation of input feature data in operation S110 of FIGS. 2 to 4.

FIG. 6 is an exemplary diagram describing data splitted by operation S110 of FIGS. 2 to 5.

FIG. 7 is an exemplary block diagram of a computing system according to an embodiment of the inventive concept.

### DETAILED DESCRIPTION

Embodiments of the inventive concept will be described below in more detail with reference to the accompanying drawings. In the following descriptions, details such as detailed configurations and structures are provided merely to assist in an overall understanding of embodiments of the inventive concept. Modifications of the embodiments described herein can be made by those skilled in the art without departing from the spirit and scope of the inventive concept. Furthermore, descriptions of well-known functions and structures are omitted for clarity and brevity. The terms used in this specification are defined in consideration of the functions of the inventive concept and are not limited to specific functions. Definitions of terms may be determined based on the description in the detailed description.

In the following drawings or the detailed description, modules may be connected to others in addition to the components illustrated in drawing or described in the detailed description. The modules or components may be directly or indirectly connected. The modules or components may be communicatively connected or may be physically connected.

Unless defined otherwise, all terms including technical and scientific terms used herein have the same meaning as can be understood by one of ordinary skill in the art to which the inventive concept belongs. Generally, terms defined in the dictionary are interpreted to have equivalent meaning to the contextual meanings in the related art and are not to be construed as having ideal or overly formal meaning unless expressly defined in the text.

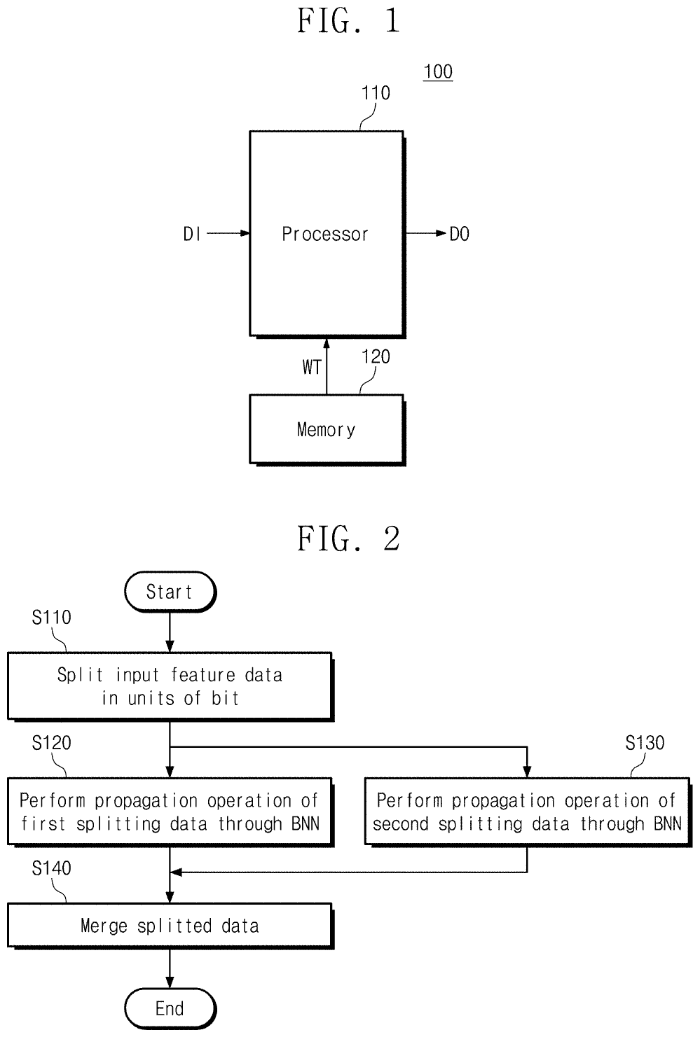

FIG. 1 is a block diagram of a neural network system according to an embodiment of the inventive concept. A neural network system 100 may generate output feature data DO by processing input feature data DI, based on a neural network. Referring to FIG. 1, the neural network system 100 includes a processor 110 and a memory 120.

The processor 110 may process and analyze the input feature data DI, based on the neural network implemented according to an embodiment of the inventive concept. The processor 110 may be a graphics processing unit (GPU). Since the GPU is efficient for parallel data processing such as matrix multiplication, the GPU may be used as a hardware platform for learning and inference of the neural network. However, the inventive concept is not limited thereto, and the processor 110 may be a central processing unit (CPU).

The processor 110 may receive a weight parameter group WT from the memory 120. The processor 110 may perform operation of the input feature data DI, based on the weight parameter group WT. The input feature data DI is propagated through the neural network implemented by the processor 110 and may be converted into the output feature data DO by the weight parameter group WT. The processor 110 may generate the output feature data DO as a result of the operation of the input feature data DI.

The neural network implemented by the processor 110 splits the input feature data DI in units of a bit, and the splitted data is propagated independently through a binary neural network. Through this, the neural network may have both advantages of the binary neural network and advantages of multi-bit processing. Detailed description of the neural network will be described later.

The memory 120 may be configured to store the weight parameter group WT. For example, the weight parameter group WT may include activation values and weights corresponding to each of layers of the neural network. For example, the memory 120 may be implemented as a volatile memory such as a DRAM, an SRAM, etc., or a nonvolatile memory such as a flash memory, an MRAM, etc.

FIG. 2 is an exemplary flowchart describing an operating method of a neural network system of FIG. 1. Each operation of FIG. 2 may be operated by the processor 110 of FIG. 1. FIG. 2 illustrates a process in which the neural network according to an embodiment of the inventive concept processes the input feature data DI as illustrated in FIG. 1 to generate the output feature data DO. For convenience of description, FIG. 2 will be described with reference to reference numerals in FIG. 1.

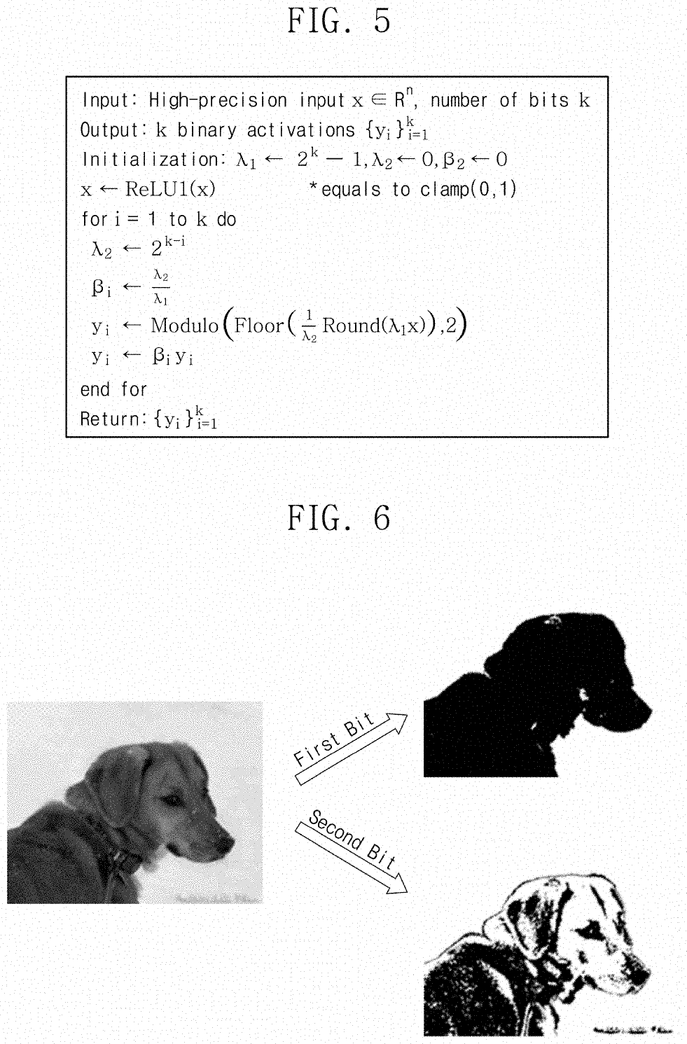

In operation S110, the input feature data DI are splitted in units of the bit. The processor 110 may split the input feature data DI, based on a set bit precision. For example, when the set bit precision is 2, the processor 110 may split the input feature data DI into first and second splitting data. In this case, the first splitting data may correspond to a first digit (e.g., most significant bit (MSB)), and the second splitting data may correspond to a second digit (e.g., least significant bit (LSB)). However, the number of the splitting data is not limited to two, and the input feature data DI may be splitted by a number greater than two. According to the set bit precision, the processor 110 may split the input feature data DI into various numbers, such as first to third splitting data or first to fourth splitting data. A detailed description of a split of the input feature data DI will be described later in detail with reference to FIGS. 4 and 5.

In operation S120, the first splitting data is propagated through a first binary neural network. In the first binary neural network, a binary activation function or the weight parameter group WT including a weight represented by 1-bit data may be used. Since a binary value is used, a computation amount of the first splitting data of the processor 110 may decrease, and a usage amount of the memory 120 may decrease. As a result of propagation of the first splitting data, the processor 110 may generate first result data.

In operation S130, the second splitting data is propagated through a second binary neural network. In the second binary neural network, the binary activation function or the weight parameter group WT including the weight represented by 1-bit data may be used. The weight parameter group WT may be shared by the first binary neural network and the second binary neural network. Accordingly, the calculation amount of the processor 110 may decrease, and the usage amount of the memory 120 may decrease. As a result of propagation of the second splitting data, the processor 110 may generate second result data.

Operation S120 is performed independently of operation S130. That is, the propagation operation of the first splitting data and the propagation operation of the second splitting data are independently performed without being related to each other. In operations S120 and S130, the operation of the first splitting data does not affect the operation of the second splitting data, and the operation of the second splitting data does not affect the operation of the first splitting data. In addition, when the input feature data DI are splitted by a number greater than 2, a propagation operation of third splitting data may be further performed independently of operations S120 and S130. In this case, the operation of the third splitting data does not affect operations of the first and second splitting data.

When image classification and object recognition are performed from the input feature data DI that are image data, bits of different digits may have meaningful information independently. Details of this will be described later in FIG. 6. In this case, an accuracy of the output feature data DO when data splitted in units of the bit is independently operated may be similar to an accuracy of the output feature data DO when the splitted data are correlated with each other. In addition, the processing speed and the memory usage when the splitted data are independently operated may be significantly improved than that when the splitted data are correlated with each other.

In operation S140, the first result data by propagation of the first splitting data and the second result data by propagation of the second splitting data are merged with each other. The processor 110 may consider an importance of the first result data and may multiply the first result data by a first weight. The processor 110 may consider an importance of the second result data and may multiply the second result data by a second weight. The first and second result data multiplied by the weights may be added, and as a result, the output feature data DO may be generated. The first and second weights may be included in the weight parameter group WT described above.

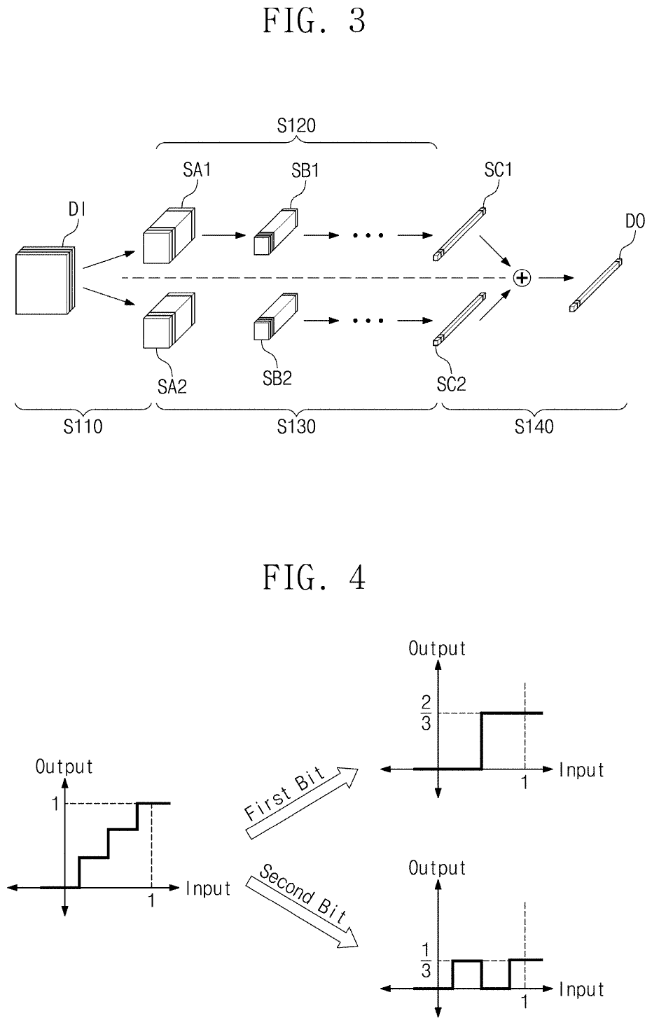

FIG. 3 is a diagram exemplarily illustrating a neural network described in FIGS. 1 and 2. FIG. 3 illustrates a process in which the neural network implemented by the processor 110 of FIG. 1 performs each operation of FIG. 2. Operations S110 to S140 illustrated in FIG. 3 correspond to operations S110 to S140 in FIG. 2, respectively.

In operation S110, the neural network may split the input feature data DI, based on a set number of bit precision. For example, it is assumed that FIG. 3 splits the input feature data DI into first splitting data SA1 and second splitting data SA2, based on 2-bit precision. However, the inventive concept is not limited thereto, and as described in FIG. 2, the input feature data DI may be split into a number greater than 2. The first splitting data SA1 corresponds to the first digit (e.g., most significant bit (MSB)), and the second splitting data SA2 may correspond to the second digit (e.g., least significant bit (LSB)).

The neural network may include a bit splitting layer for splitting the input feature data DI, and the bit splitting layer may be a first layer of the neural network. In one example, three cube blocks illustrated as the input feature data DI may include a feature map corresponding to a red color, a green color, and a blue color of an image sensor (not illustrated), and the feature map may be generated based on pixel values corresponding to the red color, the green color, and the blue color.

The bit splitting layer may convert the input feature data DI into the first splitting data SA1 having a first value or a second value. When a feature value of the input feature data DI is in a first reference range, the first splitting data SA1 having the first value may be generated. When the feature value of the input feature data DI is not in the first reference range, the first splitting data SA1 having the second value may be generated. In one example, the first reference range may be greater than or equal to a half value (e.g., ½) of a valid range that the feature value may have. The first value may be a high level (e.g., ⅔) corresponding to {10, 11}, and the second value may be a low level (e.g., 0) corresponding to {00, 01}.

The bit splitting layer may convert the input feature data DI into the second splitting data SA2 having a third value or a fourth value. When the feature value of the input feature data DI is in a second reference range, the second splitting data SA2 having the third value may be generated. When the feature value of the input feature data DI is not in the second reference range, the second splitting data SA2 having the fourth value may be generated. The second reference range may include a first sub-range that is greater than or equal to a first reference value (e.g., ⅚) greater than the half value of the valid range, and a second sub-range between a second reference value (e.g., ⅙) that is less than the half value of the valid range and the half value. The third value may be the high level (e.g., ⅓) corresponding to {01, 11}, and the fourth value may be the low level (e.g., 0) corresponding to {00, 10}.

In operation S120, the first splitting data SA1 is propagated through the first binary neural network. In addition, in operation S130, the second splitting data SA2 is propagated through the second binary neural network. The neural network includes the first binary neural network and the second binary neural network. The first binary neural network and the second binary neural network propagate data independently of each other. That is, the neural network may process each of the first splitting data SA1 and the second splitting data SA2 by using a bitwise binary activation function.

In operation S120, the first splitting data SA1 may be converted into first result data SC1 through first intermediate data SB1 by the first binary neural network. To this end, the first binary neural network may include at least one convolutional layer. The first binary neural network may generate the first result data SC1 by processing the first splitting data SA1, based on the weight parameter group WT of FIG. 1. The weight parameter group WT may be represented by the binary activation function. Accordingly, when an input data value is in a reference range, a value obtained by multiplying the input data value by the set weight value is output, and otherwise, 0 may be output.

In operation S130, the second splitting data SA2 may be converted into second result data SC2 through second intermediate data SB2 by the second binary neural network. To this end, the second binary neural network may include at least one convolutional layer. The second binary neural network may generate the second result data SC2 by processing the second splitting data SA2, based on the weight parameter group WT described as in operation S120. As in the above description, the weight parameter group WT may be represented by the binary activation function. Accordingly, when the input data value is in the reference range, a value obtained by multiplying the input data value by the set weight value is output, and otherwise, 0 may be output.

In operation S140, the first result data SC1 and the second result data SC2 are merged with each other. The neural network may include a bit merging layer for merging, and the bit merging layer may be a last layer of the neural network. The bit merge layer may multiply the first result data SC1 by the first weight, may multiply the second result data SC2 by the second weight, and may add the multiplied results to each other. The bit merging layer may output the output feature data DO as a multiplication result of the weights and the result data.

FIG. 4 is an exemplary graph of an activation function used in operation S110 of FIGS. 2 and 3. The activation functions illustrated in FIG. 4 are functions for splitting and outputting the input feature data DI in units of the bit. For convenience of description, it is assumed that the activation functions split the input feature data DI, based on the 2-bit precision. The activation functions may split the input feature data DI into the first splitting data corresponding to a first digit bit (first bit) and the second splitting data corresponding to a second digit bit (second bit).

Referring to FIG. 4, when the valid range of the input feature data DI is from 0 to 1, a level of the output data value is illustrated. The existing 2-bit activation function is illustrated on a left side of FIG. 4. Depending on the level of the input feature data DI, data having four levels corresponding to {00, 01, 10, 11} may be output, and for example, the data may have levels of {0, ⅓, ⅔, 1}. When the input feature data DI are splitted into the first and second splitting data, two activation functions may be used.

The activation function corresponding to the first bit is used to generate the first splitting data corresponding to the most significant bit, based on the input feature data DI. For example, a value of ½ or more among the input feature data DI having the valid range from 0 to 1 may be converted to ⅔, and a value less than ½ may be converted to 0. In this case, ½ is the half value of the valid range, and ½ or more may be the first reference range described in FIG. 3. The value ½ or more may be considered as the most significant bit is 1, and the value less than ½ may be considered as the most significant bit is 0. The first splitting data may have the binary value of ⅔ or 0, and may be propagated to the first binary neural network as in operation S120 described above.

The activation function corresponding to the second bit is used to generate the second splitting data corresponding to the least significant bit, based on the input feature data DI. For example, a value of ⅚ or more among the input feature data DI, or a value of from ⅙ to ½ among the input feature data DI may be converted to ⅓, and the remaining values may be converted to 0. In this case, The values of from ⅙ to ½ and ⅚ or more may be the second reference range described in FIG. 3. A value that satisfies the second reference range may be considered to have the least significant bit of 1, and the value that does not satisfy the second reference range may be considered to have the least significant bit of 0. The second splitting data may have the binary value of ⅓ or 0, and may be propagated to the second binary neural network as in operation S130 described above.

The two activation functions are used to split the input feature data DI in units of the bit for use in the binary neural network. The amount of computation for processing the input feature data DI may decrease, and the memory usage may decrease, by using the binary neural network, compared to existing neural networks that process multiple bits.

FIG. 5 is a diagram illustrating an algorithm for performing a splitting operation of input feature data in operation S110 of FIGS. 2 to 4. As an example, the algorithm illustrated in FIG. 5 may be programmed to implement the bit splitting layer of FIG. 3 or the activation functions of FIG. 4. The algorithm of FIG. 5 is exemplary, and a splitting operation in units of the bit of the input feature data according to the inventive concept is not limited by FIG. 5.

Referring to FIG. 5, the number of bits is defined as “k” bits, and the number of the activation functions or the number of the splitting data may be “k”. When the embodiments of FIGS. 3 and 4 are applied, “k” will be 2. However, a value of “k” may be greater than 2, and in this case, the number of final output values yi returned may be greater than 2. That is, the number of data to be splitted may be variously provided depending on the number of bits.

λ1 and λ2 are arbitrary parameters for a bit splitting operation, λ1 may be initialized to 2^{k}−1, and λ2 may be initialized to 0. A weight Pi is defined as a weight of i-th activation function, and the activation function may be configured to output 0 or the weight βi. In this case, the valid range of the input feature data DI is defined from 0 to 1, based on a ReLU1(x) function. Hereinafter, for convenience of description, the algorithm will be described on the assumption that “k” is 2.

In a first activation function (i=1), since 22 is set to 2k⁻¹, that is, 2, β1 is set to ⅔. That is, the set value corresponds to an output value ⅔ of the activation function corresponding to the first bit in FIG. 4. An output value y1 is calculated by a Modulo (Floor (1/λ2*round (λ1*x), 2)) function, and has the binary value of 0 or 1. The final output value y1 has the binary value of 0 or ⅔ because the binary value of 0 or 1 is multiplied by the weight β1. The final output value y1 is the same as the activation function corresponding to the first bit in FIG. 4.

In a second activation function (i=2), since 22 is set to 2k⁻², that is, 1, β2 is set to ⅓. That is, the set value corresponds to an output value ⅓ of the activation function corresponding to the second bit in FIG. 4. The output value y2 is calculated by the Modulo (Floor (1/λ2*Round (λ1*x), 2)) function, and has the binary value of 0 or 1. The final output value y2 has the binary value of 0 or ⅓ because the binary value of 0 or 1 is multiplied by the weight β2. The final output value y2 is the same as the activation function corresponding to the second bit in FIG. 4.

FIG. 6 is an exemplary diagram describing data splitted by operation S110 of FIGS. 2 to 5. Referring to FIG. 6, a puppy image on a left side corresponds to the input feature data DI of FIG. 3, and an image of an upper right side corresponds to the first splitting data SA1 of FIG. 3. An image of a lower right side corresponds to the second splitting data SA2 of FIG. 3. As mentioned above, the first splitting data SA1 corresponds to the first digit bit (e.g., most significant bit), the second splitting data SA2 may correspond to the second digit bit (e.g., a subsequent digit bit of the most significant bit).

In the image corresponding to the first splitting data SA1, a dog is clearly distinguished from a background. In addition, in the second splitting data SA2, features such as the dog's eyes, nose, and ears are prominent. In general, it has been known that bits other than the most significant bit have significant information when the bits other than the most significant bit are combined with the most significant bit. However, in a data analysis such as image classification or object recognition, it is shown that the bits of each digit may have meaningful information independently, as in the images of FIG. 6. In this case, although the data splittted in units of the bit are not correlated with each other and are independently processed, the accuracy of the output feature data DO may be secured. That is, the neural network according to an embodiment of the inventive concept may secure the accuracy of the analysis result while reducing the amount of computation and memory usage.

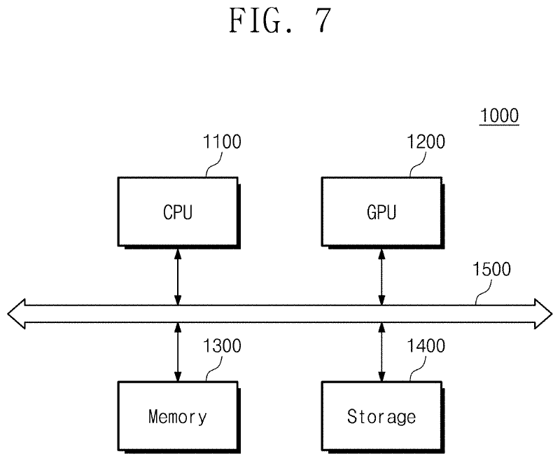

FIG. 7 is an exemplary block diagram of a computing system according to an embodiment of the inventive concept. Referring to FIG. 7, a computing system 1000 includes a central processing unit (CPU) 1100, a graphics processing unit (GPU) 1200, a memory 1300, storage 1400, and a system interconnect 1500. The neural network system 100 of FIG. 1 may be included in the computing system 1000. It will be understood that components of the computing system 1000 are not limited to the components illustrated. For example, the computing system 1000 may further include a hardware codec for processing image data, a display for displaying images, a sensor for obtaining the image data, etc.

The CPU 1100 executes software (an application program, an operating system, device drivers) to be performed in the computing system 1000. The CPU 1100 may execute the operating system (OS) loaded in the memory 1300. The CPU 1100 may execute various application programs to be run based on an operating system (OS). The CPU 1100 may be provided as a multi-core processor. The multi-core processor may be a computing component having at least two independently drivable processors (hereinafter referred to as ‘cores’). Each of the cores may independently read and execute program instructions.

The GPU 1200 performs various graphic operations in response to the request of the CPU 1100. The GPU 1200 may process the input feature data DI of the inventive concept and may convert the input feature data DI into the output feature data DO. In one example, the GPU 1200 may correspond to the processor 110 of FIG. 1. The GPU 1200 may have an operational structure advantageous for parallel processing of data, such as an operation of matrix multiplication. Therefore, the recent GPU 1200 may have a structure that may be used for various operations requiring high-speed parallel processing as well as graphic operations. In one example, the GPU 1200 may perform a general purpose operation other than a graphic processing operation, and the image classification and object recognition described above may be performed.

In the GPU 1200, the neural network described in FIG. 3 may be implemented. In one example, the GPU 1200 may split the input feature data DI in units of the bit and may propagate each of the splitted data independently through the binary neural network. As an example, in the GPU 1200, a CUDA kernel for layers of the bit splitting layer and the binary neural network may be implemented. Data propagated through the CUDA kernel may be merged, and output feature data DO may be generated. According to the neural network structure of the inventive concept, the computation amount and memory usage of the GPU 1200 are reduced, and data analysis performance may be secured depending on the bit splitting.

The operating system (OS) or basic application programs may be loaded in the memory 1300. For example, when the computing system 1000 boots, an OS image stored in the storage 1400 may be loaded into the memory 1300, based on a boot sequence. Various input/output operations of the computing system 1000 may be supported by the OS. As in the above description, the application programs may be loaded into the memory 1300 to be selected by a user or to provide basic services. The application program of the inventive concept may control the GPU 1200 to perform the bit splitting of the GPU 1200, processing of the splitting data through the binary neural network, and a merge operation.

The memory 1300 may correspond to the memory 120 of FIG. 1. The weight parameter group WT described above may be loaded into the memory 1300. For example, the weight parameter group WT stored in the storage 1400 may be loaded into the memory 1300. The weight parameter group WT may include the binary activation function or the weight represented by 1-bit data. Therefore, the inventive concept may have a smaller data size than a weight of the existing neural network that processes the multiple bits, and the usage of the memory 1300 may be reduced.

The memory 1300 may be used as a buffer memory for storing image data (e.g., the input feature data DI) provided from an image sensor (not illustrated) such as a camera. Also, the memory 1300 may be used as a buffer memory for storing the output feature data DO, which is a result of analyzing the input feature data DI. The memory 1300 may be a volatile memory such as a static random access memory (SRAM) or a dynamic random access memory (DRAM), or a nonvolatile memory such as a PRAM, an MRAM, a ReRAM, a FRAM, and a NOR flash memory.

The storage 1400 is provided as a storage medium of the computing system 1000. The storage 1400 may store the application programs, an operating system image, and various data. The storage 1400 may be provided as a memory card (MMC, eMMC, SD, MicroSD, etc.), and may include a NAND-type flash memory or NOR-type flash memory having a large storage capacity. Alternatively, the storage 1400 may include the nonvolatile memory such as the PRAM, the MRAM, the ReRAM, and the FRAM.

The system interconnect 1500 may be a system bus of the computing system 1000. The system interconnect 1500 may provide a communication path among components included in the computing system 1000. The CPU 1100, the GPU 1200, the memory 1300, and the storage 1400 may exchange data with one another through the system interconnect 1500. The system interconnect 1500 may be configured to support various types of communication formats that are used in the computing system 1000.

According to an embodiment of the inventive concept, a neural network system and operating method of the same may reduce the computation amount and memory usage, and may improve data analysis performance, by splitting feature data in units of a bit and processing the splitted feature data independently with a binary neural network.

The contents described above are specific embodiments for implementing the inventive concept. The inventive concept may include not only the embodiments described above but also embodiments in which a design is simply or easily capable of being changed. In addition, the inventive concept may also include technologies easily changed to be implemented using embodiments. Therefore, the scope of the inventive concept is not limited to the described embodiments but should be defined by the claims and their equivalents.

While the inventive concept has been described with reference to exemplary embodiments thereof, it will be apparent to those of ordinary skill in the art that various changes and modifications may be made thereto without departing from the spirit and scope of the inventive concept as set forth in the following claims.

What is claimed is:

1. A method of operating a neural network system, the method comprising:
splitting input feature data into first splitting data corresponding to a first digit bit and second splitting data corresponding to a second digit bit different from the first digit bit;
propagating the first splitting data through a first binary neural network;
propagating the second splitting data through a second binary neural network; and
merging first result data by propagation of the first splitting data and second result data by propagating the second splitting data to generate output feature data.

2. The method of claim 1, wherein the splitting of the input feature data into the first splitting data and the second splitting data includes:
generating the first splitting data, based on a first activation function that converts the input feature data in a first reference range to a first value; and
generating the second splitting data, based on a second activation function that converts the input feature data in a second reference range to a second value.

3. The method of claim 2, wherein the first reference range includes a range between a half value of a valid range of the input feature data and a maximum value of the valid range, and
wherein the second reference range includes a first sub-range including at least a portion between a minimum value of the valid range and the half value and a second sub range including at least a portion between the half value and the maximum value.

4. The method of claim 3, wherein the first value is greater than the second value.

5. The method of claim 2, wherein the first activation function converts the input feature data having a value less than ½ to 0, and converts the input feature data having a value of ½ or more to ⅔, and
wherein the second activation function converts the input feature data having a value less than ⅙ or a value from ½ to ⅚ to 0, and converts the input feature data having a value from ⅙ to ½ or a value of ⅚ or more to ⅓.

6. The method of claim 1, wherein the first digit bit is a most significant bit, and the second digit bit is a least significant bit.

7. The method of claim 1, wherein the propagating of the first splitting data includes generating the first result data, based on an operation of a weight parameter group and the first splitting data; and
wherein the propagating of the second splitting data includes generating the second result data, based on an operation of the weight parameter group and the second splitting data.

8. The method of claim 7, wherein the weight parameter group includes weights of 1 bit.

9. A neural network system comprising:
a processor configured to convert input feature data into output feature data, based on a weight group parameter; and
a memory configured to store the weight group parameter, and
wherein the processor is configured to:
split the input feature data into first splitting data corresponding to a first digit bit and second splitting data corresponding to a second digit bit different from the first digit bit;
convert the first splitting data into first result data, based on a first binary neural network and the weight group parameter;
convert the second splitting data into second result data, based on a second binary neural network and the weight group parameter; and
merge the first result data and the second result data to generate the output feature data.

10. The neural network system of claim 9, wherein the first splitting data is propagated through the first binary neural network, and
wherein the second splitting data is propagated through the second binary neural network independently of the first splitting data.

11. The neural network system of claim 9, wherein the processor generates the first splitting data, based on a first activation function that converts the input feature data in a first reference range to a first value, and generates the second splitting data, based on a second activation function that converts the input feature data in a second reference range to a second value.

12. The neural network system of claim 11, wherein the first reference range includes a range between a half value of a valid range of the input feature data and a maximum value of the valid range, and
wherein the second reference range includes a first sub-range including at least a portion between a minimum value of the valid range and the half value and a second sub range including at least a portion between the half value and the maximum value.

13. The neural network system of claim 12, wherein the first value is greater than the second value.

14. The neural network system of claim 9, wherein the first digit bit is a most significant bit, and the second digit bit is a least significant bit.

15. The neural network system of claim 9, wherein a weight provided to the first binary neural network and a weight provided to the second binary neural network are the same as the weight parameter group.

16. The neural network system of claim 9, wherein the weight parameter group includes weights of 1 bit.

17. The neural network system of claim 9, wherein the processor includes a graphics processing unit.
